(19) United States
(12) Patent Application Publication
(10) Pub. No.: US 2012/0160854 A1
(43) Pub. Date: Jun. 28, 2012

(54) SEALANT SYSTEM FOR STORAGE CONTAINER CONSTRUCTION

(76) Inventors: Dalen Defoe, Chanhassen, MN (US); Jason Ford, St. Michael, MN (US); Scott Bendix, St. Cloud, MN (US)

(21) Appl. No.: 12/976,087

(22) Filed: Dec. 22, 2010

(51) Int. Cl. B65D 85/00; F16J 15/14; E04B 1/682

(52) U.S. Cl. 220/524; 277/316; 277/628; 277/650

(57) ABSTRACT

A sealing kit and related methods of using for sealing gaps between two or more shipping containers that are used to form permanent or semi-permanent structures. The sealing kit includes a horizontal sealing material and a vertical sealing material, wherein the horizontal sealing material is essentially free-flowing and/or self-leveling and the vertical sealing material in nonflowable under the influence of gravity at typical installation temperatures above 32° F. The sealing kit further includes an expansion member for defining a retaining surface along an interface between adjacent shipping containers. The sealing kit can further comprise a plug member for defining drain holes at ends of a horizontal sealing surface.

### FIELD OF THE INVENTION

The present invention relates to the field of shipping containers and their use in quickly assembling temporary structures. More specifically, the present invention relates a sealing kit and related methods of application for waterproofing seams between adjoining shipping containers.

### BACKGROUND OF THE INVENTION

The now conventional shipping container seen frequently on ships, trains and trucks has been in use since the 1950's. Standard intermodal containers are fabricated of 0.98 inch thick corrugated steel and share common dimensions of 8 feet in height, 8 feet in width and either 20 or 40 feet in length. The containers include common attachment points at the corners allowing the containers to be lifted for loading and stacked and secured once in place on the shipping vehicle.

Due to the wide variety of environments and stresses that shipping containers can be exposed in performing their function, their design and manufacture leads to a rugged container that tends to have a long life. As would be expected with durable items that have been manufactured for decades, there are often instances in which structurally sound containers are essentially retired or otherwise not in use. The number of excess containers is also directly affected by shifts in the economy that reduce trade and consequently, the volume of international shipping.

One application for excess or retired containers has been to repurpose the shipping containers for use as base construction elements for building occupiable structures such as temporary housing, sheds and storage facilities and to quickly add excess capacity to existing permanent structures such as prisons and the like. For instance, shipping containers can quickly be deployed to provide temporary shelter to individuals who have suffered from environmental catastrophes such as floods, earthquakes and hurricanes. In a military context, shipping containers have been utilized to quickly construct military base structures such as headquarters and barracks in remote regions where conventional construction equipment is not readily available.

While the use of shipping containers to build temporary or even permanent structures is advantageous with respect to time of assembly and costs to acquire, the former applications and environments to which the shipping containers were exposed during their initial shipping duties can lead to problems in building acceptable structures. For instance, the various stresses to which the shipping containers were exposed during loading, lifting and transport can lead to the warping of surfaces leading to these surfaces no longer being square to one another. When these now warped surfaces are aligned with mating surfaces on an adjacent container, gaps can be formed such that forming water tight seals between adjacent containers is very difficult. As such, it would be advantageous to have a sealing product capable of addressing these gaps that is both easy and quick to apply so as to not negatively impact the speed in which structures can be assembled with shipping containers.

### SUMMARY OF THE INVENTION

The present invention addresses the need of sealing gaps between shipping containers by use of a sealing kit having multiple sealants wherein each sealant is specifically adapted for use in a selected sealing location. Generally, the sealing kit of the present invention comprises at least two sealing materials including a horizontal sealing material and a vertical sealing material. The horizontal sealing material is generally selected to have a viscosity wherein the material is essentially free-flowing at typical installation temperatures. The vertical sealing material is generally selected with a viscosity at typically installation temperature so as to be resistant to flow following application and subsequent curing. The sealing kit can further comprise a retention member for defining a retaining surface along both horizontal and vertical interfaces surrounding the external perimeter between adjacent shipping containers. The retention member generally comprises an expandable material capable of forming the retaining surface and accommodating gaps and dimensional differences between adjacent shipping containers. Each of the sealing materials and the retention member is capable of performing a waterproofing function independently and cooperatively provide a dual seal when utilized as part of the kit.

In one aspect of the present invention, an embodiment of a sealing kit for use in waterproofing adjacent shipping containers can comprise a retention member, a horizontal sealing material and a vertical sealing material. The retention member generally comprises an expandable member capable of forming a continuous retaining surface about the exterior perimeter, both horizontal and vertical interfaces, between adjacent shipping containers. The expandable nature of the horizontal retention member allows for successful installation between adjacent shipping containers where gaps and other dimensional discrepancies exist. The horizontal sealing member generally comprises a first sealant material having a viscosity such that it is free-flowing at installation temperatures above 32° F. The vertical sealing member generally comprises a second sealant material having a viscosity such that it is non-flowing at installation temperatures above 32° F. At upper corners of the shipping container, the retention member and vertical sealant material define drain openings allowing accumulate water to drain down the vertical sealant material.

In another aspect, the present invention can comprise a method for waterproofing a structure formed through the placement of shipping containers in adjacent relation. The method can comprise forming a retaining surface along a horizontal interface between adjacent containers. The formation of the retaining surface can further include accommodating dimensional differences and gaps between adjacent containers by expansion of a retaining member such that the retaining surface is continuous between the adjacent containers. The method can further comprise applying a vertical sealant on top of the retaining surface to form a continuous, watertight seal along the horizontal interface. Application of the vertical sealant can comprise selecting a first sealant material having a viscosity at installation temperatures above 32° F. such that first sealant is free flowing and/or semi self-leveling and forms a continuous horizontal seal on top of the retaining member and between the adjacent containers. The method can further comprise applying a vertical sealant to form a continuous, watertight seal along a vertical interface between adjacent containers. Application of the vertical sealant can comprise selecting a second sealant material having a viscosity at installation temperatures above 32° F. such that the second sealant is essentially non-flowing and maintains its position during curing so as to form a continuous vertical seal between the adjacent containers. The method can further comprise forming drain holes below iso-corners to allow accumulated water to flow from above the watertight seal along the horizontal interface.

In yet another aspect, the present invention can comprise a container structure having two or more adjacent containers with a watertight seal formed between the containers. The watertight seal generally comprises a horizontal seal formed along horizontal edges of adjacent containers as well as a vertical seal formed along vertical edges of adjacent containers. The horizontal seal can comprise a retaining member and a first sealant material. The retaining member generally comprises an expandable material that is positioned between the adjacent containers such that the retaining member can accommodate any gaps or dimensional differences between the adjacent containers. The first sealant material is generally flowable and/or self-leveling at an installation temperature above 32° F. and is positioned directly on top of the retaining member. The vertical seal comprises a second sealant material. The second sealant material is generally non-flowable at an installation temperature above 32° F. Drain holes can be defined below iso-corners at the ends of the horizontal seal to allow for accumulated water to be removed from above the first sealant material.

The above summary of the invention is not intended to describe each illustrated embodiment or every implementation of the present invention. The Figures and the Detailed Description that follow more particularly exemplify these embodiments.

### BRIEF DESCRIPTION OF THE FIGURES

The invention can be more completely understood in consideration of the following detailed description of various embodiments of the invention in connection with the accompanying drawings, in which:

FIG. 1 is a view of a sealant system kit according to a representative embodiment of the present invention.

FIG. 2 is a top perspective view of a conventional storage container of the prior art.

FIG. 3 is a partial section view of a corner region of the storage container of FIG. 2 taken at line 3-3 of FIG. 2.

FIG. 4 is a detailed perspective view of a corner region taken at Detail 4 of the storage container of FIG. 2 during a first installation step of a sealant system of the present invention.

FIG. 5 is a side view of the corner region of FIG. 4 during the first installation step of the sealant system of the present invention.

FIG. 6 is a top perspective view of a pair of storage containers positioned to form a storage container structure during a second installation step of the sealant system of the present invention.

FIG. 7 is a side view illustration of the corner region of FIG. 4 during the application of a horizontal sealing material during a third installation step of the sealant system of the present invention.

FIG. 8 is an end view illustration of a horizontal waterproof seal formed between the pair of storage containers during the third installation step of the sealant system of the present invention.

FIG. 9 is an end view of the pair of storage containers during the formation of a vertical waterproof seal as part of a fourth installation step of the sealant system of the present invention.

FIG. 10 is a detailed end view of the storage containers taken at Detail 10 of FIG. 9 during formation of the vertical waterproof seal as part of the fourth installation step of the sealant system of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE FIGURES

Referring now to FIG. 2, a conventional storage container 100 generally includes a pair of side panels 102a, 102b, a pair of end panels 104a, 104b, a roof panel 106 and a floor panel 108. Generally, storage container 100 comprises a welded, carbon steel construction with a painted exterior so as to survive years of use in the global transportation industry. To facilitate ease of loading, stacking and unloading, storage container 100 generally has standardized dimensions of 8 feet in height, 8 feet in width and either 20 or 40 feet in length. In order to facilitate lifting, stacking and retention, storage container 100 includes an iso-corner 110 mounted at each corner of the storage container 100. The iso-corners 110 can be permanently welded to the storage container 100.

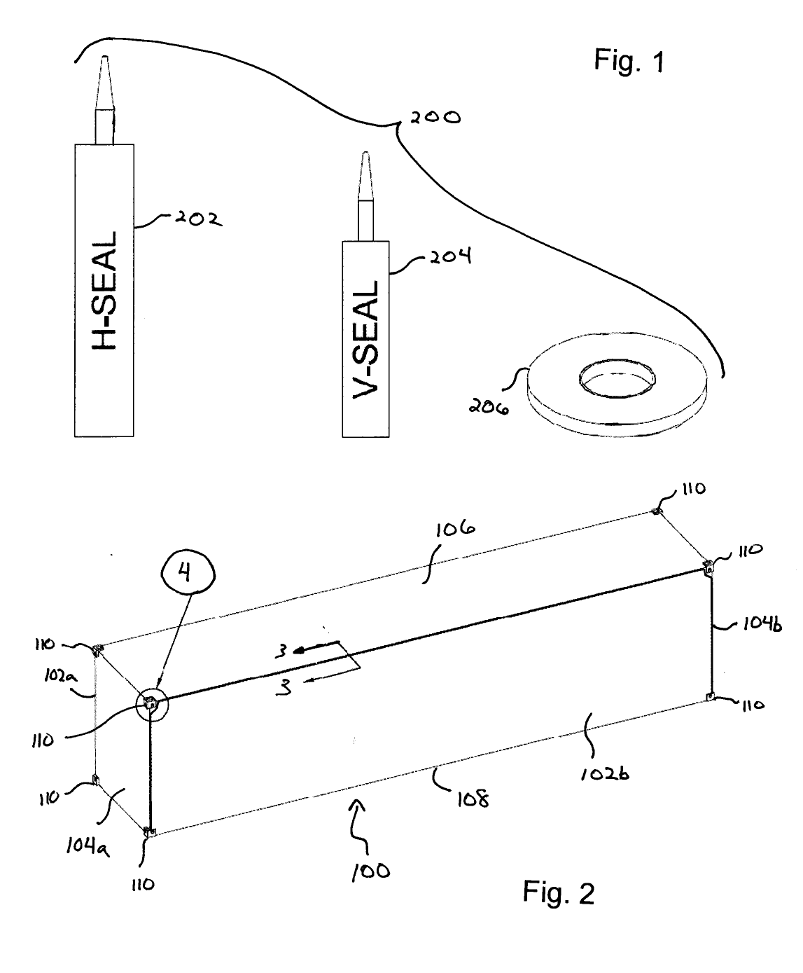

A sealant system kit 200 of the present disclosure is illustrated generally in FIG. 1. Sealant system kit 200 generally comprises a horizontal sealing material 202 and a vertical sealing material 204 and an expandable material 206. Horizontal sealing material 202 can comprise a polymer based sealant material such as, for example, a urethane, polyurethane or silicone based material having a viscosity allowing the horizontal sealing material 202 to be free flowing and/or semi self-leveling at temperatures above 32° F. Vertical sealing material 204 can comprise a polymer based sealant material such as, for example, a urethane, polyurethane or silicone based material having a viscosity such that the vertical sealing material is essentially non-flowable at temperatures above 32° F. Sealant system kit 200 can further comprise an expandable material 206. Expandable material 206 can comprise a pre-compressed, self-expanding, flexible polyurethane in a tape or rolled form.

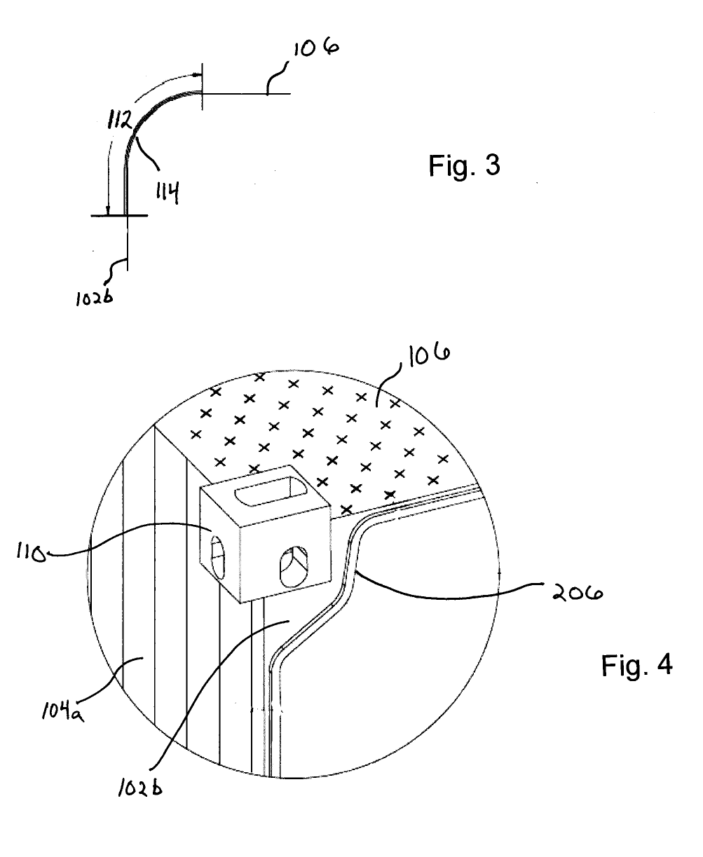

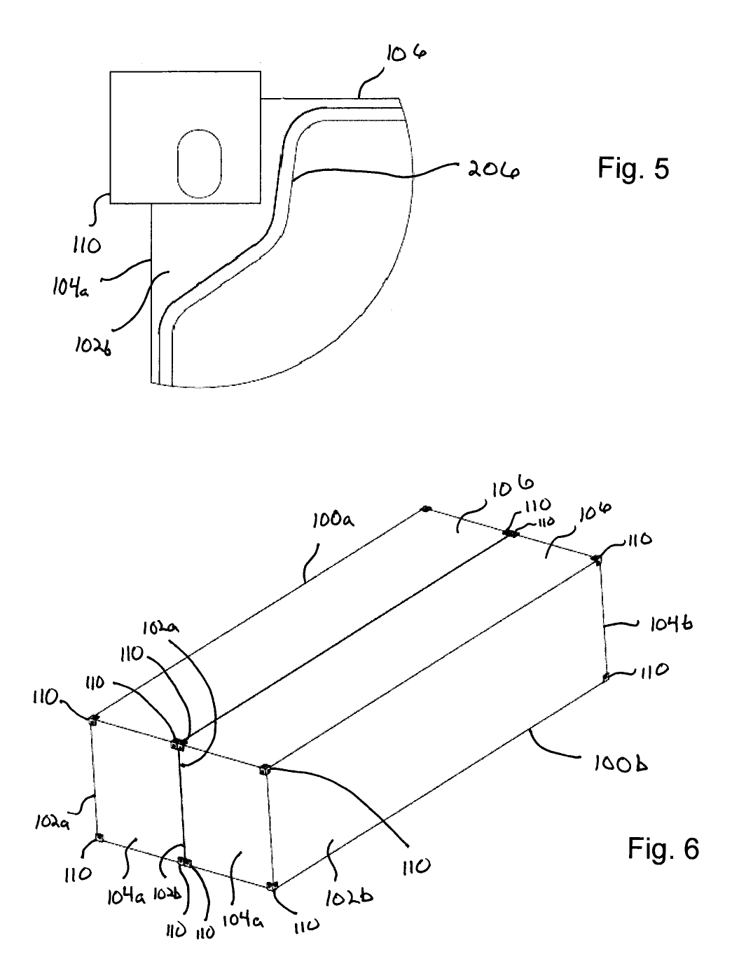

When utilized to construct a temporary, semi-permanent or permanent structures, a first storage container 100a and a second storage container 100b are pre-assembled such that corresponding side panels 102a, 102b that are to be placed into adjacent relation can be partially or totally removed so as to define doorway, entryways or to define common rooms. Typically, removal of all or portions of the side panels 102a, 102b is accomplished with a conventional welding torch or other suitable means. With the side panels 102a, 102b prepared, the first storage container 100a is placed into its desired position and a mating surface 112 comprising a radiused intersection 114 of the end panels 104a, 104b, roof panel 106 and floor panel 108 is sanded or otherwise prepped for sealing by removing any rust or loose material and giving the mating surfaces a rough finish as illustrated in FIG. 3. Referring now to FIGS. 4 and 5, the expandable material 206 is positioned on first storage container 100a along the side panel 102a proximate the roof panel 106 and end panels 104a, 104b. At a corner portion 112 proximate the intersection of roof panel 106 and end panels 104a, 104b, the expandable material 206 is positioned inside the iso-corner 110 as illustrated in FIGS. 4 and 5. In some instances, the expandable material 206 can comprise a continuous strip of material such as, for example, a pre-compressed, self-expanding, flexible polyurethane in a tape or rolled form having an adhesive allowing for positioning and retention of the expandable material 206 on the storage container 100 or alternatively, multiple sections of the expandable material 206 can be butted against one another to define the continuous strip. To provide a second layer of waterproofing, the expandable material can also be positioned surrounding doorways, entryways or window sills that are pre-defined between adjacent storage containers. Following placement of the expandable material 206 against the first storage container 100, the expandable material will begin to expand. Next, the second storage container 100b is generally placed in a side-by-side relation 110 with the first storage container 100a as shown in FIG. 6. Storage containers 100a and 100b should be arranged so as to be generally level. With the second container 100b positioned adjacent the first container 100a, the expandable material 206 expands to occupy and fill any space present corresponding mating surfaces on the first and second storage containers 100a, 100b. When the expandable material 206 is fully expanded, there are preferably no openings being visible between the first and second storage containers 100a, 100b.

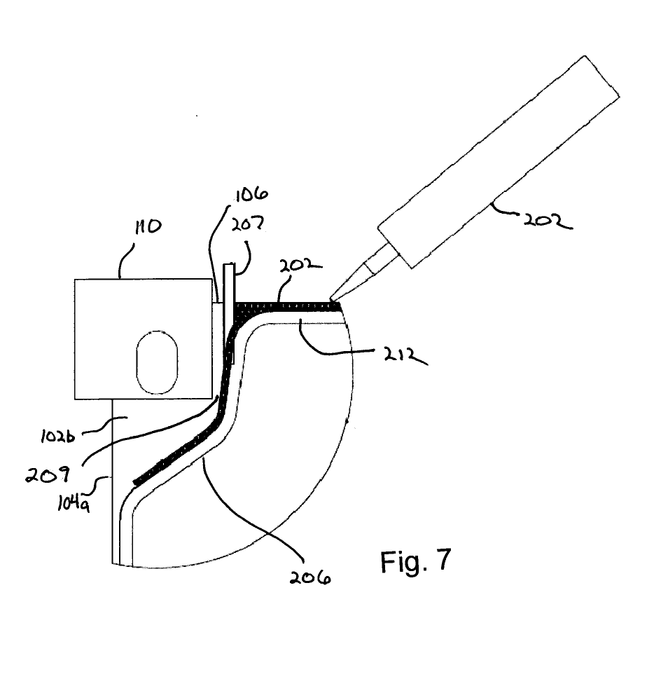

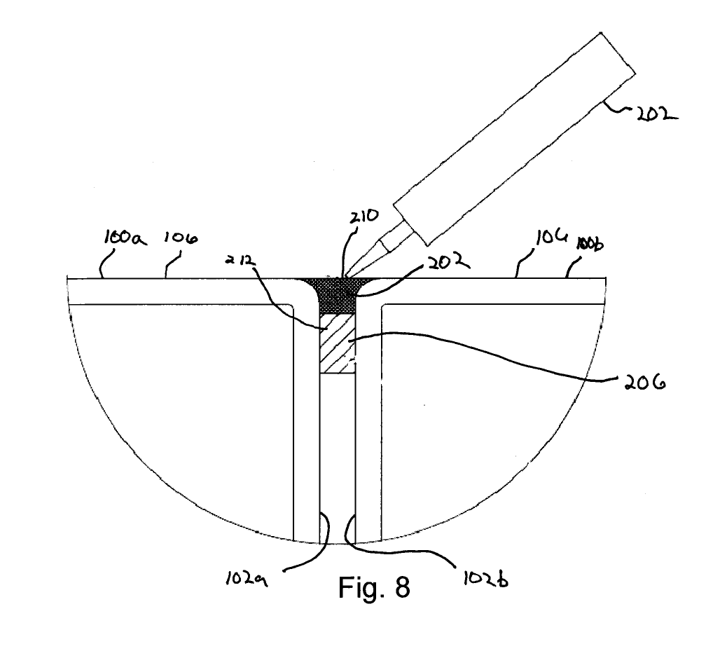

Once the expandable material 206 has fully expanded such that all visible light otherwise viewable between first and second storage containers 100a, 100b has been eliminated, horizontal sealing material 202 is applied into the gap between now adjacent iso-corners 110 on the first and second storage containers 100a, 100b as illustrated in FIG. 7. The horizontal sealing material 202 is applied such that the flowable nature of the horizontal sealing material 202 allows all of the expandable material 206 surrounding the inside of the iso-corner 110 to be covered. Under the influence of gravity, the horizontal sealing material 202 settles and self-levels on top of expandable material 206, which is otherwise acting essentially as a mold for the horizontal sealing material 202, and forms a generally flat surface that is continuous between the first storage container 100a and the second storage container 100b. A plug 207 is inserted into the gap between the iso-corner 110 and the expandable material 206 to essentially dam and retain the horizontal sealing material 202 during a curing period, typically at least 24 hours, so that the horizontal sealing material 202 is kept from flowing down the gap between the end panels 104a. Following removal of the plug 207, individual drain holes 209 are defined below each iso-corner 110 allowing any water that accumulates on the horizontal sealing material 202 to drain down the vertical sealing material 204. Once the horizontal sealing material 202 has been applied at the adjacent iso-corners 110, the horizontal sealing material 202 is applied on the expandable material 206 that is positioned between the now adjacent roof panels 106 of the first and second storage containers 100a, 100b as illustrated in FIG. 8. As best seen in FIG. 8, horizontal sealing material 202 again acts under the influence of gravity to define an essentially flat sealing surface 210 that is continuous between the first and second storage containers 100a, 100b. After sufficient curing time, horizontal sealing material 202 and expandable material 206 define a horizontal waterproof seal 212 that is virtually assured of being impervious to leaking due to the flowable nature of the horizontal sealing material 202 prior to curing.

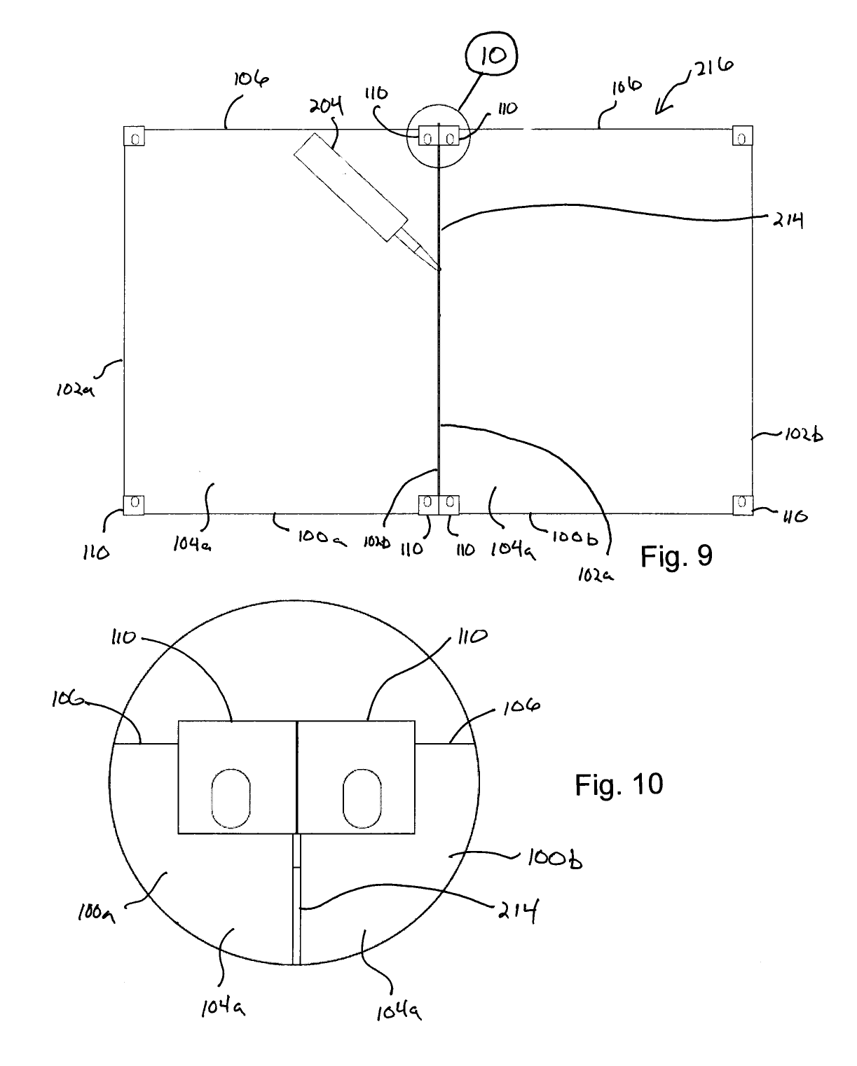

Once the horizontal waterproof seal 212 has been formed, a vertical waterproof seal 214 is created along the adjacent end panels 104a, 104b of the first and second storage containers 100a, 100b. As illustrated in FIGS. 9 and 10, the vertical waterproof seal 214 extends from a position just below the iso-corners 110 at the roof panels 106 to just above the iso-corners 110 on the floor panels 108. Vertical waterproof seal 214 is formed by applying the vertical sealing material 204 directly onto the expandable material 206. Due to the nonflowable nature of the vertical sealing material 204, the vertical sealing material 204 remains in its applied position without flowing in response to gravity as the vertical sealing material 204 cures. As the vertical sealing material 204 will not flow into a continuous level surface as previously described with respect to the horizontal sealing material 202, enough of the vertical sealing material 204 must be applied to fill the gap defined between the adjacent end panels 104a, 104b and expandable material 206. Following curing of the vertical sealing material 204, the vertical waterproof seal 214 is complete and a storage container structure 216 is ready for use.

Although specific examples have been illustrated and described herein, it will be appreciated by those of ordinary skill in the art that any arrangement calculated to achieve the same purpose could be substituted for the specific example shown. This application is intended to cover adaptations or variations of the present subject matter. Therefore, it is intended that the invention be defined by the attached claims and their legal equivalents.

1. A sealing kit for waterproofing a container structure fabricated from two or more storage containers, comprising:
a horizontal sealing material being flowable under the influence of gravity at installation temperatures above 32° F.
a vertical sealing material being nonflowable under the influence of gravity at installation temperatures above 32° F.; and
an expandable member capable of transitioning between a first compressed state and a second expanded state at installation temperatures above 32° F.

2. The sealing kit of claim 1, further comprising:
at least two plug members, each plug member engageable with the expandable member for preventing flow of the horizontal sealing material.

3. The sealing kit of claim 1, wherein the horizontal sealing material comprises a urethane, polyurethane or silicone based material.

4. The sealing kit of claim 1, wherein the vertical sealing material comprises a urethane, polyurethane or silicone based material.

5. The sealing kit of claim 1, wherein the expandable material comprises a pre-compressed, self-expanding, flexible polyurethane.

6. A method for forming a waterproof container structure, comprising:
providing a first storage container and a sealing kit, the sealing kit including an expansion member, a horizontal sealing material flowable under the influence of gravity at a temperature above 32° F. and a vertical sealing material being nonflowable under the influence of gravity at a temperature above 32° F.;
applying the expansion member along a pair of first end panel surfaces and a first roof panel surface;
positioning a second storage container alongside the first storage container such that a pair of second end panel surfaces and a second roof panel are in proximity to the corresponding first end panel surfaces and first roof panel surface;
forming a horizontal waterproof seal between the first roof panel surface and the second roof panel surface by applying the horizontal sealing material on top of the expansion member; and
forming a vertical waterproof seal between the pair of first end panel surfaces and the corresponding second end panel surfaces by applying the a vertical sealing material to the expansion member.

7. The method of claim 6, further comprising:
preparing the pair of first end panel surfaces, the first roof panel surface, the pair of second end panel surfaces and the second roof panel surface for bonding with the expansion member, the horizontal sealing material and the vertical sealing mater.

8. The method of claim 6, wherein the step of applying the expansion member further comprises:
applying the expansion member in a compressed state such said expansion member expands to fill any visible gap between the first storage container and the second storage container.

9. The method of claim 6, wherein the step of applying the expansion member further comprises:
applying the expansion member below an iso-corner located at each junction of the first roof panel and the first end panels.

10. The method of claim 6, wherein the step of forming the horizontal waterproof seal further comprises:
inserting a plug member at each iso-corner so as to prevent the horizontal sealing material from flowing downward along the expansion member between the first end panel surfaces and the second end panel surfaces; and
removing each plug member following curing of the horizontal sealing material to define a drain hole below each iso-corner thereby providing a path for accumulated water from above the horizontal waterproof seal.

11. A storage container structure, comprising:
a first storage container having a first roof panel and a pair of first end panels;
a second storage container having a second roof panel and a pair of second end panels;
a horizontal waterproof seal defined between the first roof panel and the second roof panel, said horizontal waterproof seal including an expansion member and a horizontal sealing material; and
a pair of vertical waterproof seals defined between corresponding first end panels and second end panels, said vertical waterproof seals including the expansion member and a vertical sealing material.

12. The storage container structure of claim 11, wherein the horizontal waterproof seal is defined below a pair of iso-corners at each end of the horizontal waterproof seal.

13. The storage container structure of claim 12, wherein the horizontal waterproof seal defines a drain hole below each iso-corner for removal of accumulated water from above the horizontal waterproof seal.

14. The storage container structure of claim 11, wherein the horizontal sealing material is flowable under the influence of gravity at a temperature above 32° F. prior to curing of the horizontal sealing material.

15. The storage container structure of claim 11, wherein the vertical sealing material is nonflowable under the influence of gravity at a temperature above 32° F. prior to curing of the vertical sealing material.
